(19) United States
(12) Patent Application Publication
(10) Pub. No.: US 2025/0353778 A1
(43) Pub. Date: Nov. 20, 2025

(54) SYSTEMS AND METHODS FOR HANDLING AND FORMING GLASS TUBES FOR MEDICAL USES

(71) Applicant: Euromatic S.r.l., Treviglio (BG) (IT)

(72) Inventor: Giorgio GUSMINI, Treviglio (BG) (IT)

(21) Appl. No.: 18/868,722

(22) PCT Filed: May 18, 2023
(86) PCT No.: PCT/IB2023/055103

§ 371 Date: Nov. 22, 2024

(30) Foreign Application Priority Data
May 27, 2022 (IT) 102022000011285

(51) Int. Cl. C03B 23/09; C03B 35/26

(52) U.S. Cl. CPC C03B 23/09; C03B 35/26

(57) ABSTRACT

A method for handling and forming may include: arranging glass tubes horizontally in a glass tube magazine; gripping and picking up a tube using a first manipulator from the magazine; rotating the tube gripped by the first manipulator from a horizontal position to a vertical position and inserting the tube into a revolver magazine; picking up the tube from the revolver magazine using a second manipulator; inserting the tube vertically from above into a single chuck of a first vertical rotating crown of rotating chucks; treating the tube at work stations to provide a tip-shaped end; transferring the tube to an intermediate rotating turret; releasing the single glass tube to a transfer-overturning assembly, rotating the tube to a horizontal position; inserting the tip-shaped end of the tube into a horizontal rotating chuck; and treating the tube at subsequent work stations to provide a flange-shaped end.

The present invention relates to a system for handling and forming glass tubes for medical use.

Special forming machines are used in the serial production of glass containers made from a tube for medical use (vials, bottles, cartridges and syringes).

These are products with a certain complexity, and in order to meet increasingly strict quality requirements, the single glass tube requires a very precise forming process.

In particular, in syringe production systems currently used in this technical field, to the best of the applicant's knowledge, there are provided devices and assemblies for carrying out single operations on the tube being treated, which are arranged one after another almost to provide a line that produces syringes or the like from the glass tube. In this type of production there are provided devices, stations or in-line assemblies, which act on the glass tube, shaping the free end in order to produce the tip and, after cutting, the flange, which are present on the body of the syringe.

For example, there is provided a first apparatus that groups the single glass tubes so that they are available when they require to be inserted into the subsequent forming apparatuses.

In the simplest prior art systems, the single glass tube is picked up from this magazine apparatus and is fed to the subsequent forming apparatus in which heating, forming of the tip and finally cutting of the semi-finished syringe body or length provided with a tip are carried out.

A third apparatus then receives the semi-finished syringe lengths, i.e., the lengths of glass tube provided at one end with a tip, and heats and deforms the other end to form the flange of the syringe.

Both the machines receive the glass tubes and the lengths of tube in a vertical position and process them in this position due to the fact that both these separate apparatuses have a series of chucks or grippers into which the glass tubes being processed or the lengths of semi-finished glass are inserted and blocked.

The vertical arrangement, above all of the lengths of tube, means that dirt, oil or detritus of various kind deriving from the processing operations can fall into the semi-finished tube, for example during forming of the flange.

In both these apparatuses, there are provided carousels carrying a series of peripheral chucks that block the glass tube or lengths of syringe during treatment. The chucks are rotating and, in particular in the prior art machines, are rotated by a rotation transmission chain that operates gears or pulleys integral with said chucks.

In these apparatuses it is not simple to obtain uniform rotation due to said motion transmission means. Moreover, they determine a series of vibrations caused by the gears and by the rotation transmission chain, or by the gears themselves controlled in any way, but still such as to transmit vibrations. In fact, stretching of the chains and wear or an unstable arrangement of the gears lead to these problems.

This all takes place semi-automatically, as this production, carried out on several apparatuses arranged separated, allows relatively low hourly production rates of syringes, with the danger of the products being damaged in some way or receiving foreign bodies.

Handling of the glass tube, from which a certain number of syringes without any marks on the body and completely identical to one another in shape must be produced, is particularly delicate.

Therefore, there are produced heads or crowns carrying a series of chucks or grippers that receive the single glass tube and handle it in first place to proceed with forming of the tip.

This assembly of chucks or grippers must operate in complete synchronism with one another to carry the tube or at least a portion thereof, handling it by means of specific extensions or fingers.

The document EP 1369390 by the same applicant concerns a centring device for a semi-finished glass bottle in a machine for forming glass bottles.

U.S. Pat. No. 6,557,379 relates to a method for producing glass vials between facing chucks with horizontal arrangement of the glass tube.

The chains and related elongations through wear do not allow operation in the most appropriate manner.

The general object of the present invention is to produce a system and a method for handling and forming glass tubes for medical use which is capable of solving the aforesaid problems of the prior art in a very simple, inexpensive and particularly functional way.

Another object of the present invention is to produce a system for handling and forming glass tubes for medical use without vibrations and transmissions that make correct synchronization between the parts involved difficult.

Another object of the present invention is to produce a system and a method for handling and forming glass tubes for medical use that eliminates harmful contacts between the apparatus and the glass tubes that would scratch or damage the outer and/or inner surface thereof.

One more object of the present invention is to identify a system and a method for handling and forming glass tubes for medical use that does not require transfers and interventions by operators between the various operating steps for forming the syringe from the glass tube.

The aforesaid objects are achieved by a method and a system for handling and forming glass tubes for medical use produced according to the independent claims 1 and 2 and the subclaims that follow.

The structural and functional features of the present invention and its advantages in relation to the current state of the art will be even clearer and more apparent from an examination of the following description, which refers to the accompanying schematic drawings, which show an example of embodiment of the invention. In the drawings:

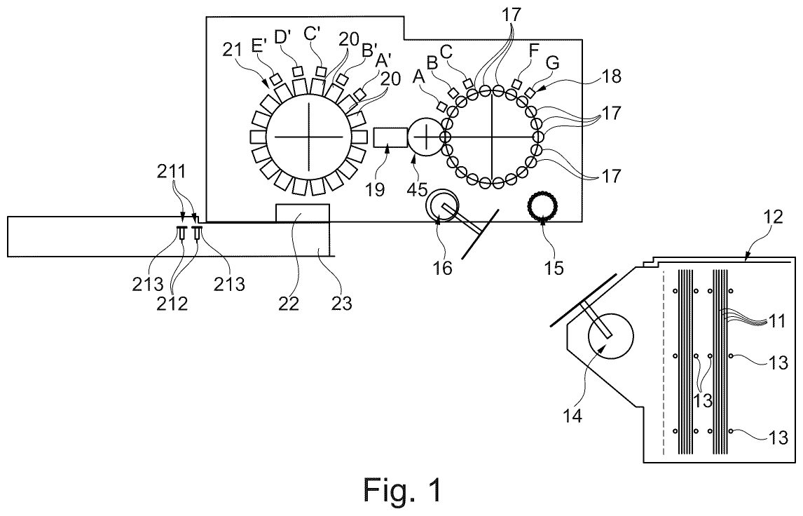

FIG. 1 is a top plan view of a diagram of the system for handling and forming glass tubes for medical use produced according to the present invention;

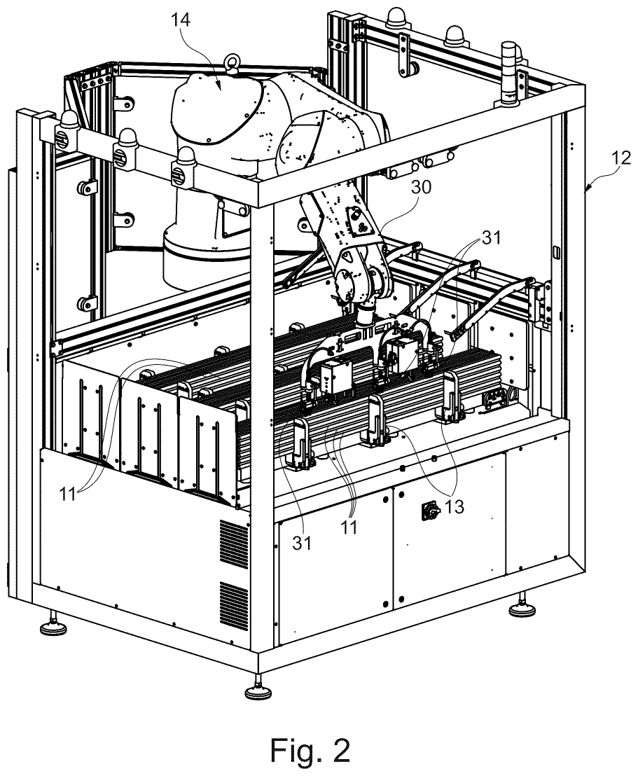

FIG. 2 shows a perspective view of an initial area of the system with a storage station of glass tubes arranged horizontally ready to be fed to a subsequent station by a manipulator;

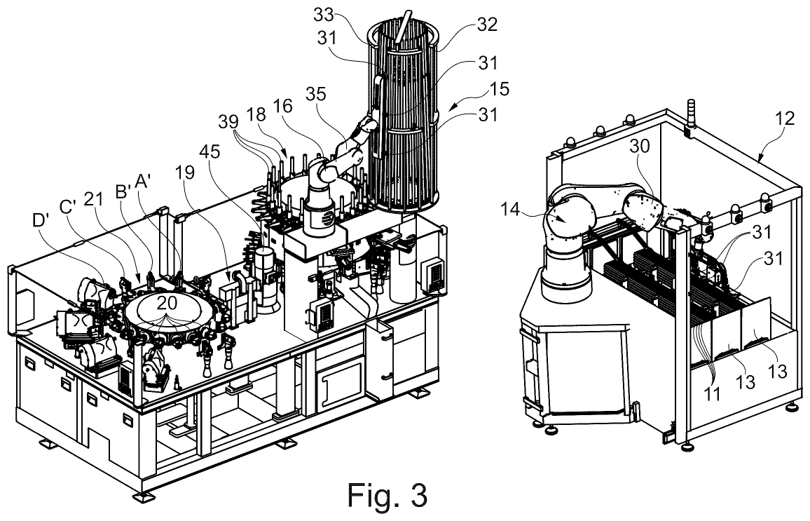

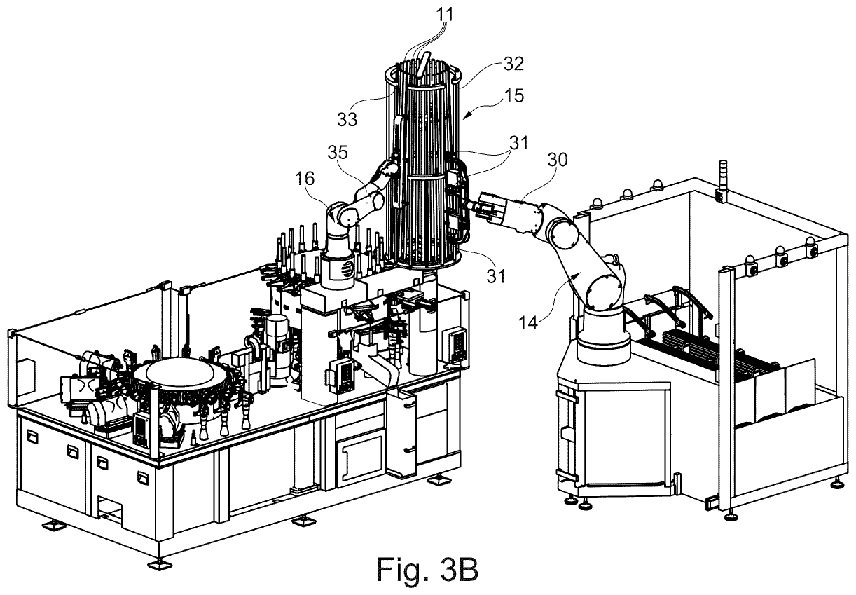

FIGS. 3 and 3B show two perspective views in different positions from a different angle of the tube storage station, of a first manipulator for picking up single tubes and inserting them into a vertical rotating magazine for glass tubes placed close to a carousel carrying a first crown of vertical rotating chucks, of a second manipulator for picking up single tubes from the rotating magazine to be inserted into the single rotating chucks provided by the first carousel, and of a second carousel of horizontal chucks;

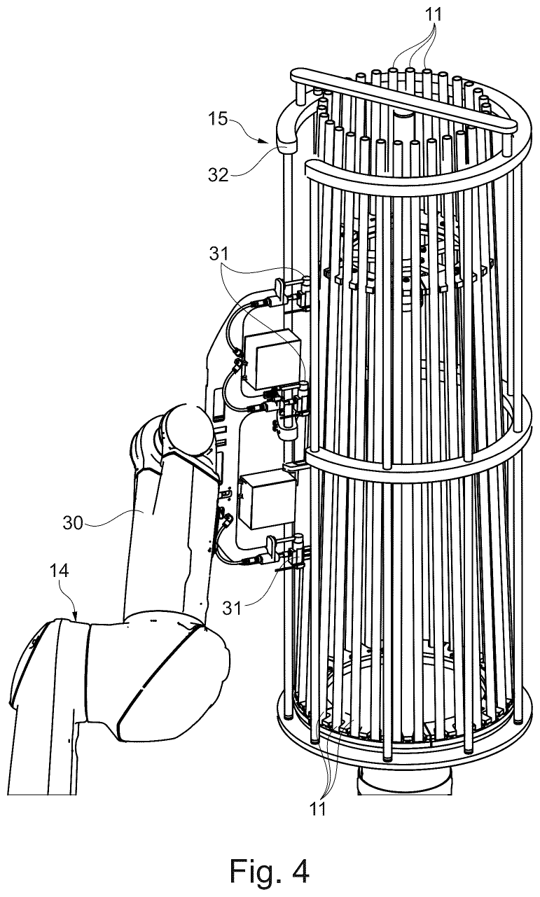

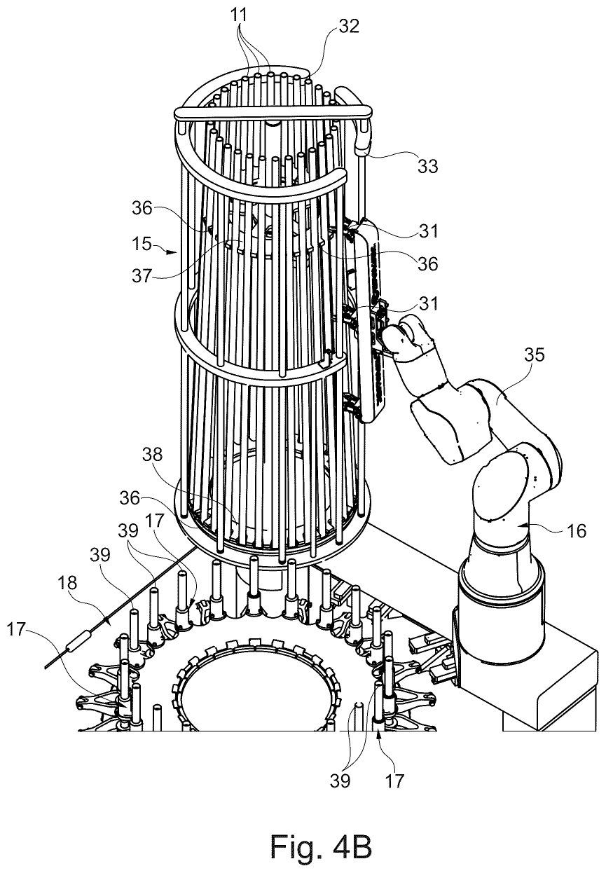

FIGS. 4 and 4B show enlarged perspective views of only the two manipulators shown in FIGS. 3 and 3B from a different angle during insertion of the glass tubes and during pick-up of the glass tubes;

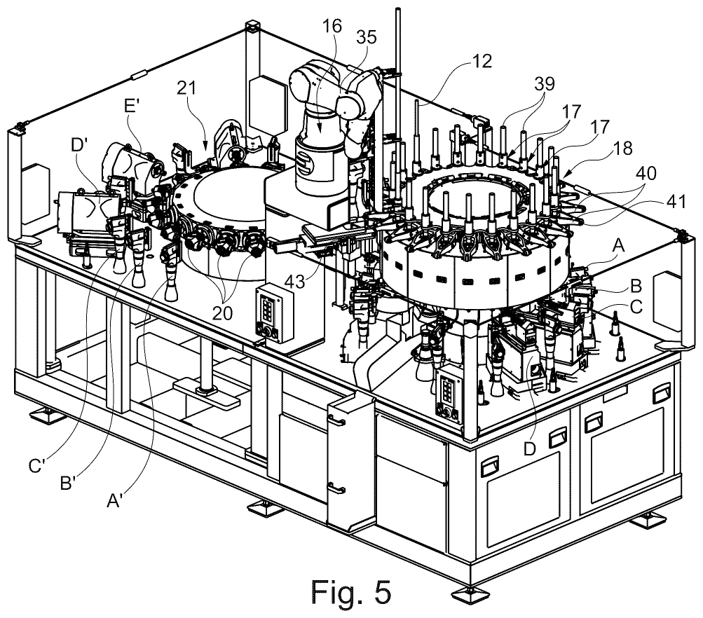

FIG. 5 shows a perspective view highlighting the second manipulator during insertion of the single glass tube into one of the chucks of the first carousel;

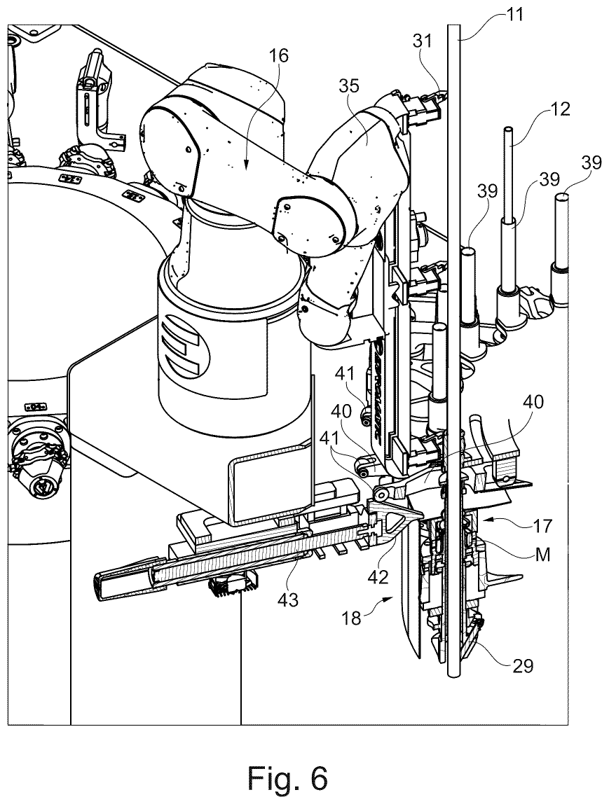

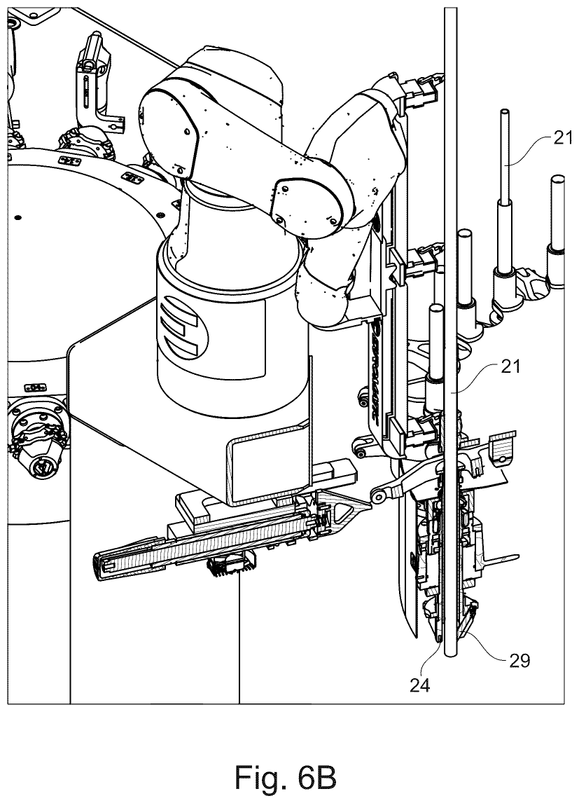

FIGS. 6 and 6B show an enlarged view of the parts of the system that allow this insertion of the tube into the chuck and blocking of said tube in the chuck of the carousel;

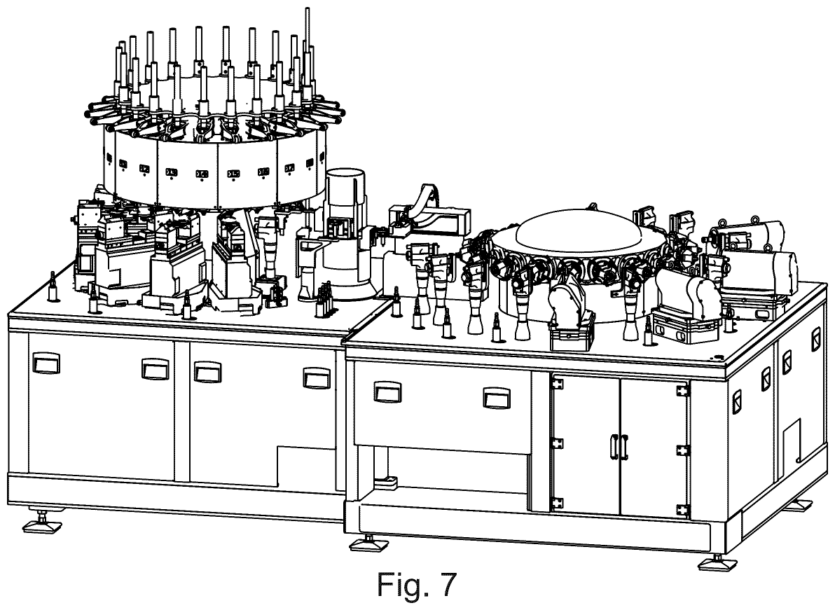

FIG. 7 shows a perspective view of the whole system from a different angle highlighting the various processing stations of the glass tube both in the first carousel and in the second carousel and its passage during cutting of the length of tube with tip and gripping thereof by an intermediate turret with four positions for transfer to a subsequent transfer and overturning assembly of the length with tip, before reaching the second carousel;

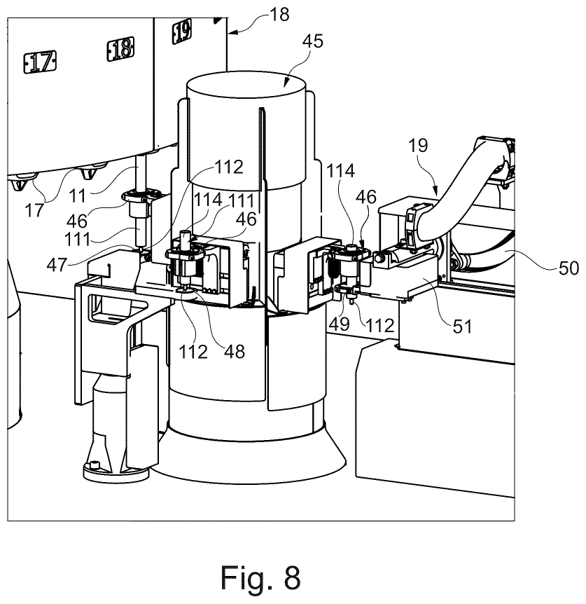

FIG. 8 shows a further perspective view of the turret which in three positions thereof shows in a first position gripping of the tube with tip, movement through 90° into a second position in which it is moved inside the gripping jaw to reach the correct position of the jaw to allow its release in the third position to a further jaw of the transfer and overturning assembly of the length with tip;

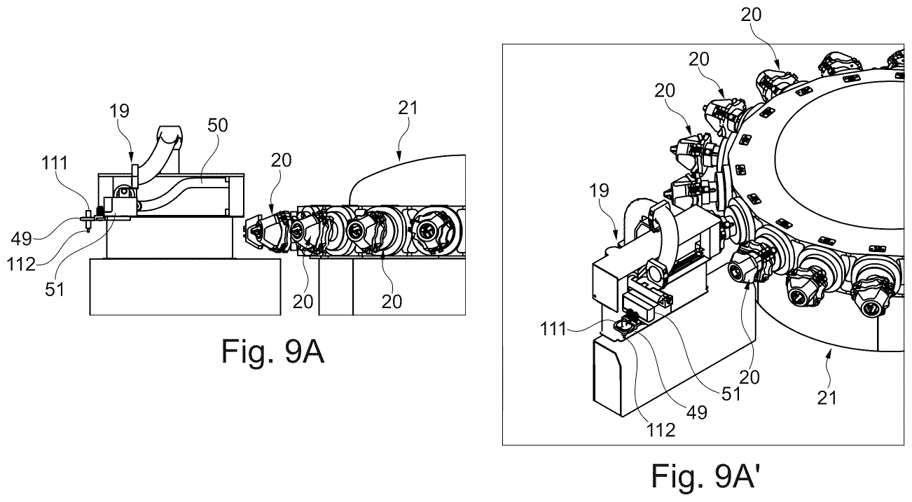

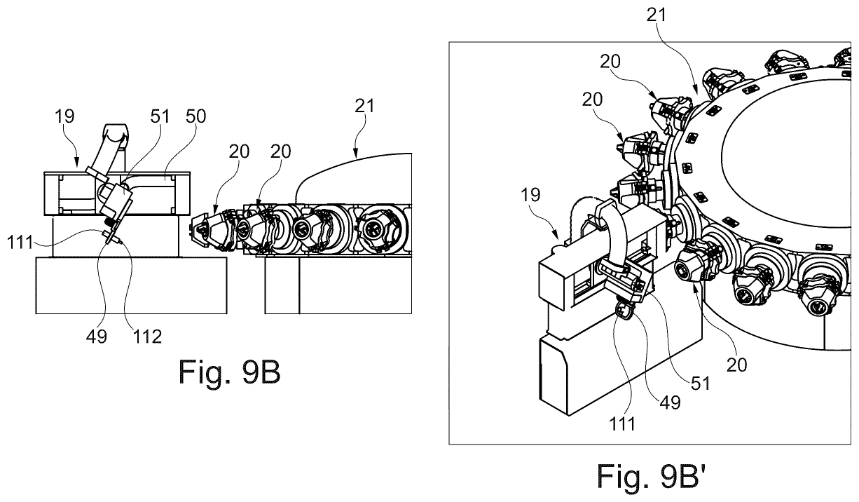

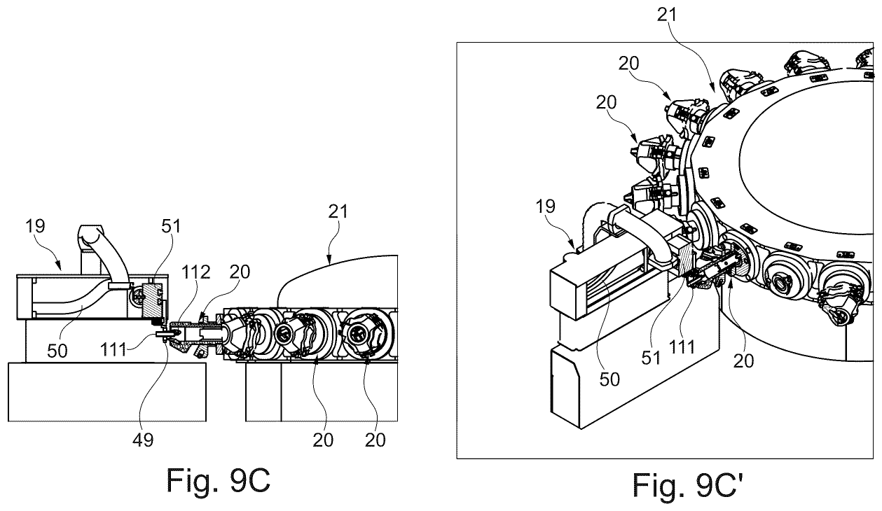

FIGS. 9A, 9A′, 9B, 9B′ and 9C, 9C′ show, in perspective and partially sectional views, the transfer and overturning assembly of the length with tip that allows such length to be transferred from a vertical receiving position, to an intermediate partially rotated position, to a horizontal release position toward the second rotating crown of rotating chucks;

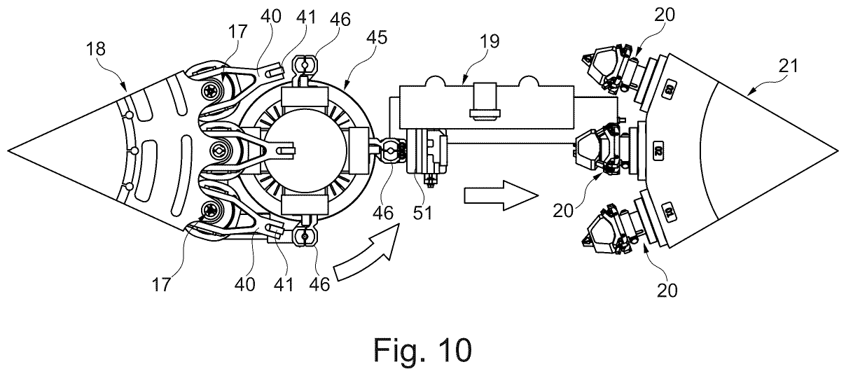

FIG. 10 shows an enlarged top plan view of three chucks of the first carousel aligned with the carousel and with the transfer and overturning assembly to pass finally to a horizontal rotating chuck belonging to a second carousel in which the flange is produced in the length of glass tube.

In the following description, for illustration of the figures identical reference numbers are used to indicate components with the same function. Moreover, for clarity of illustration, some reference numbers may not have been repeated in all the figures.

Indications such as “vertical” and “horizontal”, “upper” and “lower” (in the absence of other indications) must be interpreted with reference to the assembly (or operating) conditions and referring to normal terminology in use in current language, where “vertical” indicates a direction substantially parallel to the direction of the gravitational force vector “g” and horizontal indicates a direction perpendicular thereto.

With reference to the figures, provided by way of non-limiting example, there is shown an embodiment of a system for handling and forming glass tubes for medical use, such as, as said, bottles, cartridges and syringes.

In particular, this embodiment shows a system for handling and forming glass tubes for medical use for producing syringes, which operates completely autonomously and which prevents any intrusion of foreign bodies or scratching or marking of the surface of the glass tube and/or of the syringe body during operation.

FIG. 1 shows a plan view of the schematic layout of the system provided with a static magazine 12 of glass tubes 11 arranged horizontally on specific pallets 13, a first manipulator 14 for gripping and picking up the single glass tube 11 from the static magazine 12, rotating said glass tube until it is positioned vertically and inserting it into a near vertical position into a revolver magazine 15 rotating in steps, arranged after the manipulator 14.

A subsequent second manipulator 16 picks up the single glass tube 11 present in the rotating revolver magazine 15 and inserts it from above into a single chuck 17 belonging to a first vertical rotating crown 18. This rotating crown 18 is composed of a series of vertical rotating chucks 17 which are moved to subsequent work stations A, B, C, D, etc. arranged around the first rotating crown 18.

In this way, there is produced in this first rotating crown 18, a semi-finished product 111, formed by a length of glass tube provided at one end with a tip 112 and arranged in vertical direction.

This is followed by a transfer and overturning assembly 19 that receives this semi-finished tube 111 provided with tip in vertical position and moves it by rotating it into horizontal position before transferring it, inserting it into a horizontal rotating chuck 20 belonging to a second rotating crown 21 of rotating chucks 20.

This second rotating crown 21 is composed of a series of horizontal rotating chucks 20, which are arranged radially relative to the axis of the second crown and which are moved and carried to subsequent work stations A′, B′, C′, D′, etc., arranged around the rotating crown.

At the end of this rotation in the horizontal rotating chucks 20 of the second rotating crown 21, finished syringe bodies 211 complete with tip 112 and with flange 113 are obtained, and which are unloaded in an unloading station 22 towards a linear conveyor 23 that transports single syringe bodies 211 thus formed.

More precisely, as shown in FIG. 2, in the static magazine 12 the glass tubes 11 are arranged horizontally on specific pallets 13, consisting of lateral shoulders, for example in three stacks spaced from one another as shown in FIG. 2.

The first manipulator 14 for gripping and picking up the single glass tube 11 one at a time from the static magazine 12 comprises a first manipulator arm 30, for example provided with three grippers 31 which are actuated by a control, for example an electric control. These grippers 31 grip the single tube 11 in three positions spaced apart along its extension and, once the glass tube has been gripped, the manipulator arm 30 rotates said tube 11 so that it passes from a horizontal position to a vertical position.

FIG. 3 once again shows such plant with the first manipulator 30 in the step of gripping a horizontal glass tube 11 from the static magazine 12, while the second manipulator 16 is gripping a vertical glass tube from the rotating revolver magazine 15 to insert it into a rotating chuck of the first rotating crown 18. It is seen how the second manipulator 16 for gripping and picking up the single glass tube 11 comprises a second manipulator arm 35, for example also provided with three grippers 31 which are actuated by a control, for example an electric control.

FIG. 3B shows the same section when the manipulator arm 30 of the first manipulator 14 has reached the rotating revolver magazine 15. After reaching this, it is arranged with the arm 30 carrying a glass tube 11 gripped in vertical position facing a position for inserting it into a revolver magazine 15 rotating in steps, arranged after the manipulator.

Again in FIG. 3B it is shown how the first arm 30 with the glass tube 11 gripped penetrates the rotating revolver magazine 15, which acts as vertical storage buffer and is provided with a cylindrical containing structure. This cylindrical structure (FIG. 4) is provided along sections of vertical lateral surface of an opening 32 for inserting glass tubes and respectively of an opening 33 for picking up glass tubes.

Insertion of the glass tube 11 takes place, as said, by the first arm 30 of the first manipulator 14 with the glass tube 11 gripped penetrating the rotating revolver magazine. The subsequent pick-up instead takes place by the second manipulator 16, provided with a second arm 35, which passing through the pick-up opening 33 grips a glass tube 11 to insert it above a rotating chuck 17.

The second arm 35 of the second manipulator 16 then passes through the second pick-up opening 33 of the revolver magazine 15, which acts as vertical storage buffer, and picks up the single tube 11 arranged vertically in this second station.

It must be noted that the single tubes 11 are arranged placed in circumferential f two vertical crowns 37, 38 spaced apart. The upper crown 37 has a smaller diameter relative to the lower crown 38, so that the glass tubes 11 thus received are inclined toward the vertical rotation axis thereof and are stable in position, preventing the glass tubes 11 thus placed from being damaged on their outer surfaces.

The single glass tube 11 picked up by the second arm 35 of the second manipulator 16 is carried to and above the first vertical rotating crown 18 composed of a series of work stations and of vertical rotating chucks 17.

In this way, the second manipulator 16 inserts the single glass tube 11 into a vertical tubular element 39 carried at the upper end of each of the vertical rotating stations or of the single vertical rotating chucks 17.

In fact, in addition to this tubular guide element 39 of the single glass tube 11, each of these vertical stations is also provided with a rotating chuck 17, the lower end of which is provided with gripping fingers 29. The second manipulator 16 therefore inserts the glass tube 11 into the tubular element 39, and hence into the open chuck 17, until said glass tube 11 projects by a predetermined amount from the rotating gripping chuck 17 passing inside it.

During this operation to insert the single glass tube 11 into the rotating chuck 17, this insertion is implemented as a control arm 40 positioned at the upper end of the rotating chuck 17 keeps the fingers 29 of the rotating chuck 17 open.

This open position of the fingers 29 is determined by the fact that a free end of the control arm 40 is provided with a wheel 41 that engages on an wedge-shaped end 42 of an end of an opening lever 43. This opening lever 43 is arranged close to the rotating crown 18 in a fixed station in which the glass tube 11 is inserted into each rotating chuck 17 one after another as each chuck reaches this position.

The wedge-shaped end 42 engages on the wheel 41 of the control arm 40 and determines lifting thereof and this lifting determines retraction of the fingers 29, freeing the passage for the glass tube 11, which is simultaneously inserted into the rotating chuck 17 by the second manipulator 16.

After the glass tube 11 has descended fully into the chuck 17 for a predetermined length, the opening lever 43 and hence the wedge-shaped end 42 are disengaged from the control arm 40 that acts on the fingers 29 of the chuck 17, which thus block the glass tube 11 that has been inserted to size.

Therefore, a first rotating crown 18 with a series of rotating chucks 17 that act on the single glass tube 11, said glass tube being arranged in each of these chucks vertically.

The collaboration of an aforesaid series of external stations A′, B′, C′, D′, etc. arranged around the rotating crown 18 collaborate and act on the part of the glass tube 11 projecting downwards carried and blocked in the single rotating chuck 17 of the first rotating crown 18.

It is in this way that a glass tube semi-finished product 111 is produced. In fact, subsequent stations are provided for arranging the projecting end of the tube to size with trimming, stations for flame heating of this projecting end, stations for forming this projecting end to produce the tip interposed between flame heating stations, and so forth, up to a station for cutting and unloading the tube or length of tube 111 provided with the tip shaped end 112.

After these series of processing operations carried out on the rotating chucks 17, the semi-finished product or tube or length of tube 111 provided with the tip shaped end 112 is advanced to be carried, as will be seen, to the second rotating crown 21 of horizontal rotating chucks 20.

It must be borne in mind that a further characterizing element of the system according to the present invention consists of the arrangement of a chuck rotation motor M for each single rotating chuck 17. Therefore, the first vertical rotating crown 18 is composed of a series of vertical rotating stations in which each station has a vertical rotating chuck 17 with its own independent motor M, also rotating together with the rotating crown 18. This is obtained due to the fact that a motor or servomotor M, arranged on the axis of said chuck, is associated with each chuck.

Returning now to the description of the system, it is highlighted how the semi-finished product or tube or length of tube 111 provided with the tip shaped end 112 is advanced to the second rotating crown 21 mentioned at the beginning of the description.

To this end, there is provided an intermediate rotating turret 45 with four positions, which allows transfer of the semi-finished product 111 provided with tip 112 and cut to size to the second rotating crown 21 in which the semi-finished product, which during transfer has been moved from a vertical position to a horizontal position, is received arranged horizontally.

The rotating turret 45 is provided at each of the four positions with a jaw gripping element 46 that acts on the lateral surface of the semi-finished tube 111.

This rotating turret 45 in a first position receives the final part of the semi-finished tube 111 provided with tip 112 when it is positioned with an end thereof on an abutment surface 47, and cuts it to the predetermined size.

The semi-finished tube 111 provided with tip 112 is then transferred to a second position of the rotating turret 45 in which a further abutment surface 48 allows the semi-finished tube 111 to slide inside the jaw 46. This takes place as the latter is controlled to widen until a free tubular end 114, opposite the tip 112, projects from said jaw 46, which blocks it once again.

In a third position the semi-finished product 111, carried by the jaw 46, is positioned to face a gripper 49 of a transfer-overturning assembly 19 that is placed there in order to move the semi-finished tube 11 from a vertical position to a horizontal position.

This change of the position of the semi-finished tube 111 takes place during transfer by the aforesaid gripper 49 that gripped it in an area close to the final end of the semi-finished tube.

In the transfer position between turret 45 with four positions and transfer-overturning assembly 19, the semi-finished tube 111 is gripped almost at a free end of the tubular part by the jaw 46 of the rotating turret 45 and close to a central area by a gripper 49 of the transfer-overturning assembly 19, leaving the area provided with tip 112 free. When the jaw 46 of the rotating turret 45 releases it, the gripper 49 of the transfer-overturning assembly 19 starts its travel in said transfer-overturning assembly.

Due to a shaped cam path 50 produced and provided in this transfer-overturning assembly 19, the gripper 49, which is carried by a carriage that follows the cam 51, during its movement from an initial position to a final position, rotates through ninety degrees so that the semi-finished tube 111 is positioned horizontally.

FIGS. 9A and 9B show perspective and partially sectional views of the transfer-overturning assembly 19 of the length of glass tube 111 provided with tip 112 that receives said length in a vertical receiving position, exactly as it was arranged in the first rotating crown 18.

The movement of the carriage 19 carrying the gripper 49 ensures that, as the latter has to follow the cam path 50, as it advances this causes a rotation of the carriage 19. FIGS. 9B, show perspective and partially sectional views of the 9B′ transfer-overturning assembly 19 of the length 111 with the carriage that has already reached an intermediate position of the cam path 50 and is thus arranged in a partially rotated intermediate position.

Finally, FIGS. 9C, 9C′ show how the transfer-overturning assembly 19 of the length of glass tube allow such length 11 to be arranged in a horizontal release position toward the second rotating crown 21 of rotating chucks 20.

In this final position, the tip 112 of the semi-finished tube 111 is facing the subsequent station of the system, i.e., the second carousel 21, in which forming of the flange 213 on a product indicated with 211 provided with tip 212 takes place. More precisely, the aforesaid second rotating crown 21, which is composed of a series of rotating chucks 20, in this case horizontal, is arranged downstream of the transfer-overturning assembly 19. The rotating chucks 20 are arranged radially and perpendicularly relative to the axis of the rotating crown and are moved and carried to subsequent work stations A′, B′, C′, D′, etc. arranged around the rotating crown.

This second rotating crown 21 is provided with a series of horizontal rotating chucks with end fingers facing outwards. In this way, each chuck 20 receives just as an open gripper the semi-finished tube 111 provided with tip at one end horizontally with the tip produced previously facing the chuck 20 and penetrating between the fingers thereof, leaving the free end of the semi-finished tube projecting, which as said is arranged horizontally.

This second crown 21 is also rotating and during rotation a flange is produced at the free end of the semi-finished tube provided with tip projecting from the single chuck 20. The semi-finished tube thus retained by each rotating chuck 20 is in fact carried by the second rotating crown 21 to flame heating stations, flange forming stations interposed with flame heating stations, polishing and cooling stations, up to a station for unloading the tube or length of tube provided with a tip shaped end and now with the other flange shaped end, hence in the form of a final syringe body.

It must be noted how, with regard to what was indicated above in relation to the system, the rotating chucks 17, 20 provided in the two rotation crowns 18, 21, each of which rotates due to a respective motor/servomotor M, are an important feature.

As each of the rotating chucks 17, 20 is provided with a motor/servomotor M, the desired operating cycle can be easily implemented: slow rotation, fast rotation or halting rotation in the positions for receiving the length, cutting the flange and unloading the finished product.

On the contrary, in conventional machines, the change of speed at the various stations is not possible and halting rotation takes place with clutch/brake assemblies that are relatively complex, rudimental and not always reliable.

Moreover, the system according to the present invention is provided with a first crown of vertical chucks 17 when the glass tube 11 has not yet been subjected to processing operations and a second rotating crown 21 of horizontal rotating chucks 20 when the flange is to be produced on the tube already provided with tip.

Unlike known systems in which the lengths of tubes being processed are always arranged vertically, the horizontal arrangement of the second crown of chucks prevents dirt, oil or various kinds of detritus deriving from processing operations from falling into the semi-finished product.

The absolute absence of drive chains for chuck rotation and gears or pulleys integral with said chucks prevents any annoying noise and the possibility of malfunctioning due to slack, wear and deterioration.

The possibility of non regular rotation caused by said known motion transmission means is eliminated as, according to the present invention, each rotating chuck is provided with its own motor/servomotor M. Vibrations caused by the gears and by the rotation drive chain, which in the prior art controls chuck rotation, are also eliminated.

Moreover, the elimination of these types of transmission with high frictions allow high hourly production rates of syringes, without the danger of the products being damaged or receiving foreign bodies. The single rotating chucks also allow the glass tube to be handled without causing any marks on the outer surface and maintaining the initial shape.

With the system illustrated and described it is advantageously possible to use an innovative method for handling and forming glass tubes for medical use.

In fact, in such system there is implemented a method for handling and forming glass tubes for medical use, suitable for producing perfect syringe bodies provided with tip and flange meeting the needs of uniformity and cleanliness required.

This system comprises a series of steps that are listed below:
arranging glass tubes vertically in a glass tube magazine arranged on specific pallets;
gripping and picking up a single glass tube by a first manipulator for gripping and picking up the single glass tube from the magazine;
rotating said glass single tube gripped by said manipulator for gripping and picking up from a horizontal to a vertical position and inserting said glass tube into a revolver magazine rotating in steps, arranged after the manipulator, to produce a crown of glass tubes arranged in a near vertical position;
picking up a single glass tube from said rotating revolver magazine by a second glass tube manipulator.

This is followed by the steps of:
inserting said glass tube arranged vertically into a single chuck belonging to a first vertical rotating crown of rotating chucks from above, maintaining the lower end fingers of said chucks open until reaching a predetermined length of the glass tube upon which said fingers are closed on the inserted glass tube;
treating said glass tube inserted into said rotating crown composed of a series of vertical rotating chucks, moving each of said chucks that retain the glass tube to subsequent work stations arranged around the rotating crown, said work stations comprising at least one station for arranging the free end of the tube to size with trimming, stations for flame heating stations, tip forming stations interposed with flame heating stations, up to a station for cutting and unloading the tube or length of tube provided with a tip shaped end.

These steps are followed by further steps of:
gripping said tube or length of tube provided with a tip shaped end with a jaw belonging to an intermediate rotating turret with several positions that allows transfer of the tube or length of tube provided with a tip shaped end and moving the gripping position on the lateral surface of the tube or length of tube provided with a tip shaped end before sending it to the subsequent treatment;
releasing said tube or length of tube provided with a tip shaped end arranged vertically to a transfer-overturning assembly that receives said vertical semi-finished tube provided with tip and moves it, rotating it to a horizontal position before transferring it to a horizontal rotating chuck belonging to a second rotating crown of rotating chucks;
inserting an end provided with tip of said tube or length of tube provided with a tip shaped end into a horizontal chuck belonging to said second rotating crown of rotating chucks;
treating said glass tube inserted into said rotating crown composed of a series of horizontal rotating chucks moving each of said chucks that retain the glass tube by the tip shaped end, carrying the end of said tube provided with tip shaped end to subsequent work stations arranged fixed around the second horizontal rotating crown, said work stations comprising at least one station for arranging the free end of the tube to size with trimming, flame heating stations, flange forming stations interposed with flame heating stations, up to an unloading station of the tube or length of tube provided with a tip shaped end and with the other flange shaped end.

Advantageously, and in an absolutely novel and original way, according to the method said vertical chucks of said first rotating crown and said horizontal chucks of said second rotating crown are each individually motorized.

In this way the objects mentioned in the introduction of the description are achieved.

The scope of protection of the present invention is defined by the appended claims.

1. A method for handling and forming glass tubes for medical uses in a system configured to produce syringe bodies, the method comprising:
arranging the glass tubes horizontally in a glass tube magazine on pallets;
gripping and picking up a single glass tube using a first manipulator for gripping and picking up the single glass tube from the glass tube magazine;
rotating the single glass tube gripped by the first manipulator from a horizontal position to a vertical position and inserting the single glass tube into a revolver magazine configured to rotate in steps, in succession to the first manipulator, to produce a crown of glass tubes in near vertical position;
picking up the single glass tube from the revolver magazine using a second manipulator;
inserting the single glass tube vertically from above into a single chuck of a first vertical rotating crown of rotating chucks, maintaining lower end fingers of the single chuck open until reaching a predetermined length of the single glass tube upon which the lower end fingers are closed on the single glass tube;
treating the single glass tube inserted into the first vertical rotating crown, moving the single chuck that retains the single glass tube to subsequent work stations fixed around the first vertical rotating crown, where the subsequent work stations comprise at least one station for arranging a free end of the single glass tube to size with trimming, stations for flame heating, and/or tip forming stations interposed with flame heating stations, up to a station for cutting and unloading the single glass tube or a length of the single glass tube provided with a tip-shaped end;
gripping the single glass tube or the length of the single glass tube provided with the tip-shaped end with a jaw belonging to an intermediate rotating turret with several positions that allow transfer of the single glass tube or the length of the single glass tube to subsequent treatment, and also positioning to size moving a gripping position on a lateral surface of the single glass tube or the length of the single glass tube provided with the tip-shaped end before sending the single glass tube or the length of the single glass tube provided with the tip-shaped end to the subsequent treatment;
releasing the single glass tube or the length of the single glass tube provided with the tip-shaped end to a transfer-overturning assembly that receives the single glass tube or the length of the single glass tube provided with the tip-shaped end and moves the single glass tube or the length of the single glass tube provided with the tip-shaped end, rotating it to a horizontal position before transferring it to a horizontal rotating chuck belonging to a second rotating crown of vertical rotating chucks;
inserting the tip-shaped end of the single glass tube or the length of the single glass tube provided with the tip-shaped end into a horizontal rotating chuck belonging to the second rotating crown of horizontal rotating chucks; and
treating the single glass tube or the length of the single glass tube provided with the tip-shaped end inserted into the second rotating crown comprised of a series of the horizontal rotating chucks, moving each of the horizontal rotating chucks that retain the single glass tube or the length of the single glass tube provided with the tip-shaped end, carrying a free end of the single glass tube or the length of the single glass tube provided with the tip-shaped end to subsequent work stations fixed around the second rotating crown, the subsequent work stations comprising at least one station for arranging the free end of the single glass tube or the length of the single glass tube provided with the tip-shaped end to size with trimming, flame heating stations, flange forming stations interposed with flame heating stations, up to a station for unloading the single glass tube or the length of the single glass tube provided with the tip-shaped end and with a flange-shaped end;
the method further providing for individual motorization of each of the vertical rotating chucks of the first rotating crown and of each of the horizontal rotating chucks of the second rotating crown.

2. A system for handling and forming glass tubes for medical uses, the system comprising:
a static magazine of the glass tubes arranged horizontally on pallets;
a first manipulator for gripping and picking up a single glass tube from the static magazine, and for rotating the single glass tube until the single glass tube is positioned vertically to be inserted into a revolver magazine rotating in steps, arranged after the first manipulator;
a second manipulator for picking up the single glass tube present in the revolver magazine and inserting the single glass tube into a rotating chuck of a first vertical rotating crown;
the first vertical rotating crown, comprising a series of single vertical rotating chucks;
a series of glass tube work stations around the first vertical rotating crown to produce a tip-shaped end of the single glass tube;
a transfer-overturning assembly configured to receive a semi-finished glass tube provided with a tip in a vertical position and configured to move the semi-finished glass tube, rotating the semi-finished glass tube to a horizontal position before transferring the semi-finished glass tube, inserting the semi-finished glass tube into a horizontal rotating chuck belonging to a second rotating crown; and
the second rotating crown, comprising a series of horizontal rotating chucks arranged radially relative to an axis of the second rotating crown and which are moved and carried to subsequent work stations around the second rotating crown;
wherein each of the vertical rotating chucks of the first rotating crown and each of the horizontal rotating chucks of the second rotating crown are individually motorized.

3. The method of claim 1, wherein an opening lever that determines opening of the lower end fingers in each of the rotating chucks of the first vertical rotating crown is at a fixed station external to the first vertical rotating crown.

4. The method of claim 3, wherein the opening lever is provided with a wedge-shaped end configured to engage a control arm for lifting the lower end fingers of each of the rotating chucks of the first vertical rotating crown.

5. The method of claim 1, wherein the transfer-overturning assembly comprises a gripper configured to grip a length of the glass tube provided at the free end with the tip produced in the first rotating crown, and
wherein the gripper is on a carriage configured to follow a shaped cam path integral with the transfer-overturning assembly so that the gripper is carried from an initial position, in which the length of the glass tube is positioned vertically, to a final position, rotated through ninety degrees, in which the length of the glass tube is positioned horizontally.

6. The method of claim 1, wherein the intermediate rotating turret comprises four positions between the first vertical rotating crown and the transfer-overturning assembly, and
wherein the intermediate rotating turret comprises at least one jaw configured to grip a vertical length of a glass tube released by a rotating chuck of the first vertical rotating crown and to release the vertical length of the glass tube to a gripper of the transfer-overturning assembly.

7. The method of claim 1, wherein an opening lever that determines opening of the lower end fingers in each of the rotating chucks of the first vertical rotating crown is provided with a wedge-shaped end configured to engage a control arm for lifting the lower end fingers of each of the rotating chucks.

8. The method of claim 1, wherein motion of the vertical rotating chucks of the first rotating crown involves no drive chains, gears, or pulleys.

9. The method of claim 1, wherein motion of the horizontal rotating chucks of the second rotating crown involves no drive chains, gears, or pulleys.

10. The method of claim 1, wherein the motorization of the vertical rotating chucks of the first rotating crown is provided by individual motors or servomotors associated with each of the vertical rotating chucks.

11. The method of claim 10, wherein the individual motors or servomotors associated with each of the vertical rotating chucks allow individual control of rotation speed for each of the vertical rotating chucks.

12. The method of claim 10, wherein the individual motors or servomotors associated with each of the vertical rotating chucks allow individual control of rotation position for each of the vertical rotating chucks.

13. The method of claim 1, wherein the motorization of the horizontal rotating chucks of the second rotating crown is provided by individual motors or servomotors associated with each of the horizontal rotating chucks.

14. The method of claim 13, wherein the individual motors or servomotors associated with each of the horizontal rotating chucks allow individual control of rotation speed for each of the horizontal rotating chucks.

15. The method of claim 13, wherein the individual motors or servomotors associated with each of the horizontal rotating chucks allow individual control of rotation position for each of the horizontal rotating chucks.

16. The method of claim 1, wherein grippers of the first manipulator are actuated by electrical control.

17. The method of claim 1, wherein grippers of the second manipulator are actuated by electrical control.

18. The method of claim 1, wherein the revolver magazine isolates the first vertical rotating crown from unwanted vibrations associated with the glass tube magazine.

19. The method of claim 1, wherein the intermediate rotating turret and the transfer-overturning assembly isolate the second rotating crown from unwanted vibrations associated with the first vertical rotating crown.

20. The method of claim 1, wherein a horizontal orientation of the glass tubes in the second rotating crown reduces contamination of the glass tubes during formation of a finished product.
